(19) United States
(12) Patent Application Publication
(10) Pub. No.: US 2015/0092312 A1
(43) Pub. Date: Apr. 2, 2015

(54) CIRCUIT FOR PROTECTING AN ELECTRONIC CONTROL UNIT (ECU) FROM HIGH ENERGY PULSES

(71) Applicant: Sivakumar Govindarajan, Chennai (IN)

(72) Inventor: Sivakumar Govindarajan, Chennai (IN)

(21) Appl. No.: 14/503,905

(22) Filed: Oct. 1, 2014

(30) Foreign Application Priority Data
Oct. 1, 2013 (IN) 1132/KOL/2013

(51) Int. Cl. H02H 9/00; H02H 9/04

(52) U.S. Cl. CPC H02H 9/005; H02H 9/04
USPC 361/111

(57) ABSTRACT

A circuit for protecting an electronic control unit (ECU) from a high energy pulse is disclosed herein. The circuit includes an input node to receive a voltage from a vehicle associated with the ECU; a low power transient voltage suppressor (TVS) diode connected via first node to an input node and via a second node to the ECU, the first node being propagated voltage vie the input node, and a transistor connected, wherein a source of the transistor is connected to the first node and a drain of the transistor is connected to the second node.

### CROSS-REFERENCE TO RELATED APPLICATIONS

This U.S. Patent Application claims priority to Indian Patent Application No. 1132/KOL/2013, filed on Oct. 1, 2013 entitled “A PROTECTION CIRCUIT FOR PROTECTING ELECTRONIC CONTROL UNIT FROM AUTOMOTIVE HIGH ENERGY TRANSIENTS,” the entire disclosure of the application being considered part of the disclosure of this application and hereby incorporated by reference.

### BACKGROUND

An electronic control unit (ECU) is a generic term for any embedded system that controls one or more of the electrical system or subsystems in a motor vehicle. Types of ECU include electronic/engine control module (ECM), powertrain control module (PCm), transmission control module (TCM), brake control module (BCM or EBCM), central control module (CCM), central timing module (CTM), general electronic module (GEM), body control module (BCM), suspension control module (SCM), control unit, or control module. Taken together, these systems are sometimes referred to as the car's computer. (Technically there is no single computer but multiple ones.) Sometimes one assembly incorporates several of the individual control modules (for example, a PCM is often both an engine and transmission).

Protecting the ECU from high energy transients is a continuing issue in automotive field. Various interactions with pulses and other electrical interference may cause deleterious effects to the ECU system. FIG. 1 illustrates an example of a voltage pulse (a high energy pulse) 100 that happens for a short period of time (a transient) that may cause an ECU to fail or not operate properly.

Thus, if the high energy pulses are not handled properly it may prove destructive for the ECUs. There have been several techniques employed to address high energy pulses.

FIGS. 2(a) and (b) illustrate examples of circuits 200 and 210 for protecting a ECU 250 from a high energy pulse 100 as implemented conventionally.

Referring to FIG. 2(a), a transient voltage suppressor (TVS) diode 220 is employed to shunt the energy to ground 260, thereby absorbing the energy from the high energy pulse 100, and converting it to heat. In order to provide this operation, a TVS diode of a specific or predetermined size may be employed. The sizes required may be relatively large, and cost prohibitive. In addition, certain other problems may occur, such as reverse battery protection, and it may be expensive to provide copper in a PCB to dissipate the heat.

Referring to FIG. 2(b), the transients are cut off from getting in to system using an active switch 230 selectively turned on and off via a control 240. In this technique, the ECU 250 is cut off from the node that is sourcing the high energy pulse 100. However, in this implementation, the power lines are also cut off, which the ECU 250 from operation (unless another source of power is provided, such as a capacitor). Thus, while the ECU 250 is protected

The active switch 230 may be any sort of transistor device employed for high voltage operation, such as a bipolar junction transistor or a field effect transistor.

### SUMMARY

The aspects disclosed herein provide a method, circuit and system for protecting a ECU from high energy pulses. The circuit disclosed herein allows for the employment of a low power low power TVS diode.

A circuit for protecting an electronic control unit (ECU) from a high energy pulse, includes an input node to receive a voltage from a vehicle associated with the ECU; a low power transient voltage suppressor (TVS) diode connected via first node to an input node and via a second node to the ECU, the first node being propagated voltage vie the input node, and a transistor connected, wherein a source of the transistor is connected to the first node and a drain of the transistor is connected to the second node.

### BRIEF DESCRIPTION OF THE DRAWINGS

The above-mentioned and other features and other advantages of the invention will be better understood and will become more apparent by referring to the exemplary embodiments of the invention, as illustrated in the accompanying drawings, wherein

FIG. 1 illustrates an example of a voltage pulse (a high energy pulse) that happens for a short period of time (a transient) that may cause an ECU to fail or not operate properly.

FIGS. 2(a) and (b) illustrate examples of circuits 200 and 210 for protecting a ECU 250 from a high energy pulse 100 as implemented conventionally

FIG. 3 illustrates an example of a system 300 for protecting an ECU 310 from high energy pulses.

FIGS. 4 and 5 illustrate example circuits 400 and 500 for implementing the system in FIG. 3.

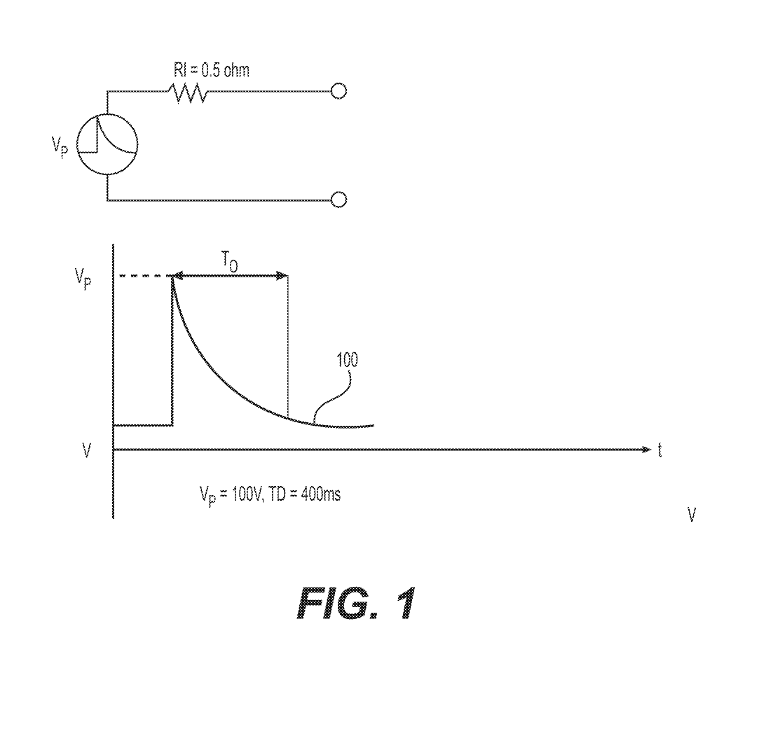

FIG, 6 illustrates an example circuit 400 with a voltage diagram 600 illustrating the operation of low power TVS diode 304.

### DETAIL DESCRIPTION OF THE INVENTION

Reference will now be made to the exemplary embodiments of the invention, as illustrated in the accompanying drawings. Where ever possible same numerals will be used to refer to the same or like parts.

An Electronic control unit (ECU) is employed in a vehicle to control and operate various electrically systems in the vehicle. In certain cases, high voltages are generated at a specific transient condition that may destroy the ECU or cause the ECU to not operate properly.

Certain techniques exist for address this situation. However, the techniques employ a high powered TVS or control circuitry that inadvertently shuts off operation to the ECU. Thus, the techniques currently employed are limited to a specific type of diode or an operation that lessens the efficiency of the ECU.

Disclosed herein are a circuit, method, and system for protecting an ECU from high energy pulses. Employing the aspects disclosed herein, an implementation of an ECU may effectively be protected from high energy pulses that may destroy the ECU or cause the ECU to not operate properly. Employing the aspects disclosed herein, a smaller circuit or device may be realized, while the ECU may remain operational while the ECU is being protected from a high energy pulse.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

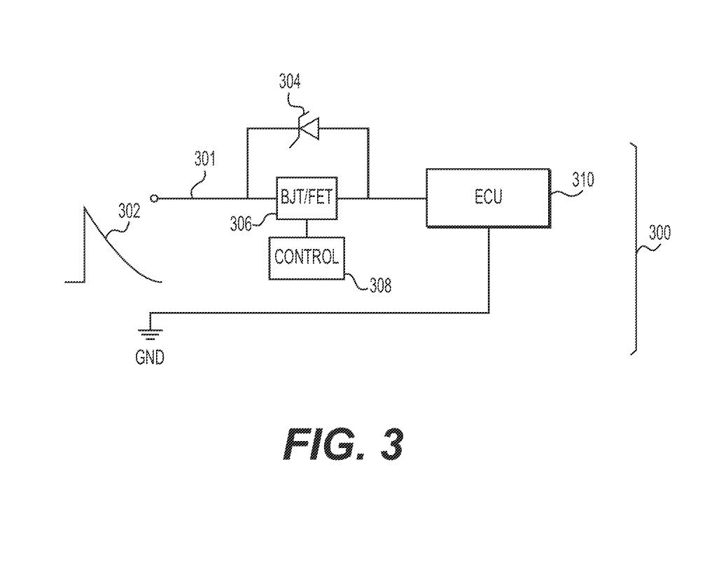

FIG. 3 illustrates an example of a system 300 for protecting an ECU 310 from high energy pulses. The circuit 300 includes an input node 301 that allows the ECU 310 to communicate and propagate electrical signals (with a voltage and current component) to other electronic systems in a vehicle.

A low power TVS diode 304 is connected in series to the load 310 and the input node 301. During a high voltage pulse 302, to limit the voltage applied to the load within safer operating region, the low power TVS diode 304 serves to regulate the amount of voltage that an ECU 310 is delivered.

A transistor 306 may also connect via one terminal to an input node 301 and the ECU 310. The transistor 306 may be a BJT or a FET, for example. The transistor 205 may be tied to a control circuit 308.

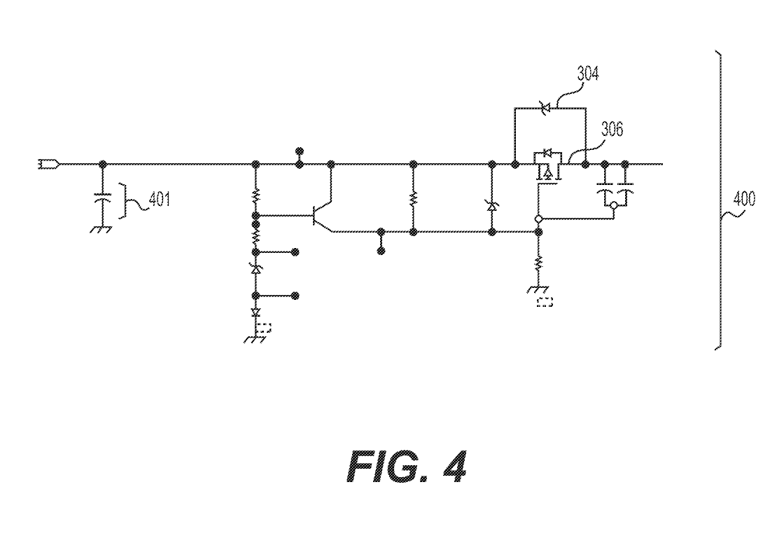

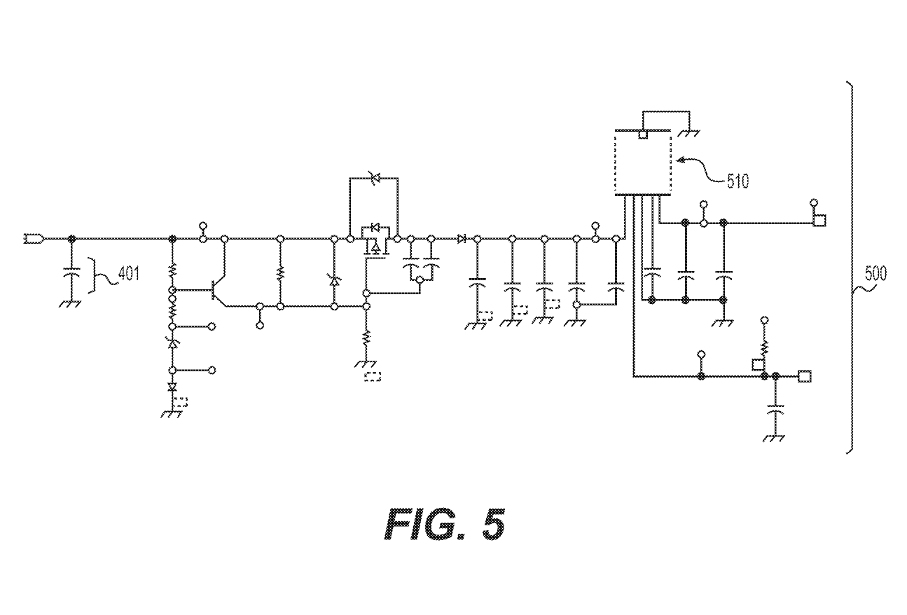

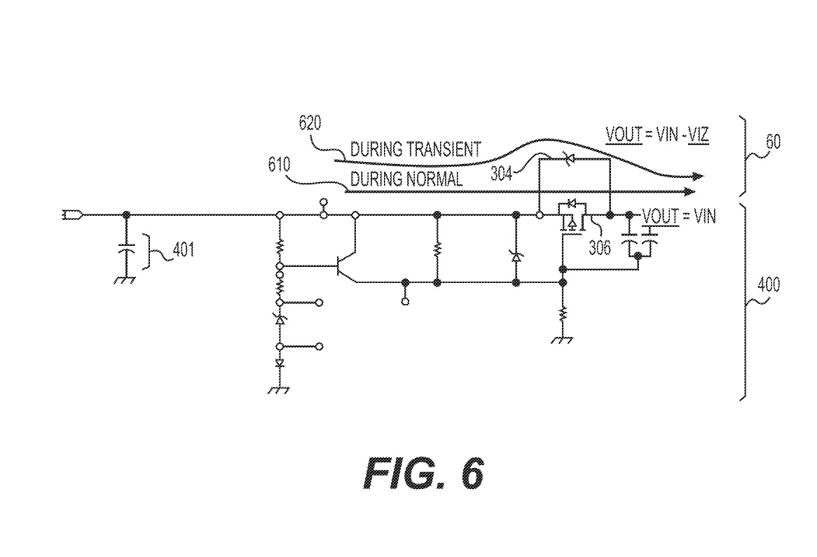

FIGS. 4 and 5 illustrate example circuits 400 and 500 for implementing the system in FIG. 3.

The circuits 400 and 500 include an input tank capacitor 401. The input tank capacitor 401 may be employed to supply power at an input voltage range within predefined series transistor cut off threshold voltage and the predefined breakdown voltage of a low power TVS diode 304 for protecting the ECU 310. FIG. 4 illustrates an implementation with a circuit 400 that includes a transistor 306 and a low power TVS diode 304. FIG. 5 illustrates an implementation of a circuit 500 and a chip 510 that integrates the functionality of a low power TVS diode 304 and the control circuitry 308.

FIG. 6 illustrates an example circuit 400 with a voltage diagram 600 illustrating the operation of low power TVS diode 304. During a normal operation 610, the Vout voltage=Vin voltage. Thus, all the voltage that is seen at an input node 301 is also propagated to an output node.

In a transient operation 620, the voltage rises above a certain value, and some of the voltage is propagated through the low power TVS diode 304. In this case, the low power TVS diode 304 dissipates some of the high energy pulse 302's deleterious effects. Thus, in this case, because some of the energy is lost due to the TVS diode 304, the voltage seen at the output is Vout=Vin−Vz.

In the example shown in FIG. 6, Q101 is a saturated switch under normal condition providing continuous power to load/downstream circuit. Z101 does not conduct under normal conditions. During high voltage transient condition, Q101 enters into cut off mode. The cut off threshold voltage is set by Z101. The threshold voltage may be 39V. This clamps gate-source of Q101 thru Q102. Z101 starts to conduct when the transient is above breakdown voltage (Vz) which provides clamped voltage to load/downstream circuit.

Voltage to the ECU 310 in this situation is Vin-Vz.

For example, in case of breakdown voltage of 56V, for transient of 100V, Vout=100−56=44V.

Between 39V to 56V (dead band), the input tank capacitor 601 supplies load/downstream during dead band avoiding the ECU 310 from turning off. By preventing that, certain effects may be avoided, for example, memory being lost in the vehicle's computing system.

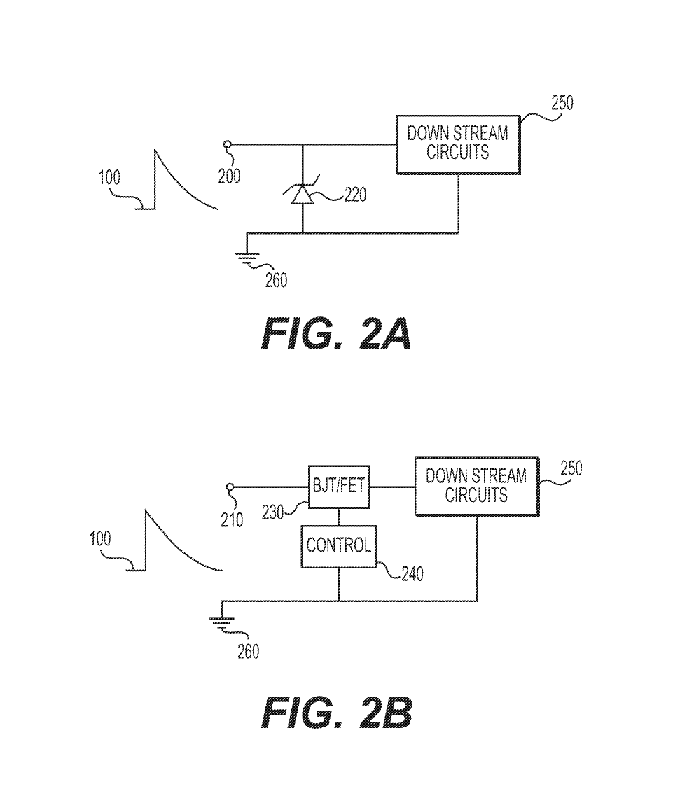

As the ECU 310 acts as a load to the low power TVS 304, the power dissipation required for the low power TVS 304 is lessened. This is due to the fact that, for example, in the implementation shown in FIG. 2(a), the ECU 310 does not load the TVS element. However, in the examples shown in FIGS. 3-5, the low power TVS diode 304 is loaded.

A clamping category IV load dump with extreme energy maybe employed for the low power TVS diode. This can also be used to clamp medium energy high voltage transients with the help of zeners instead of TVS in the proposed invention. This solution can be used in typical automotive temperature range (−40C to 125C).

The aspects disclosed herein employ a low power TVS diode and low breakdown voltage BJT/FET. Because low power elements are employed, lower costs may be achieved. Further, a ECU halt period may be avoided with the employment of a small tank capacitor.

It is to be understood by a person of ordinary skill in the art that various modifications and variations may be made without departing from the scope and spirit of the present invention. Therefore, it is intended that the present invention covers such modifications and variations provided they come within the ambit of the appended claims and their equivalents.

We claim:

1. A circuit for protecting an electronic control unit (ECU) from a high energy pulse, comprising:
an input node to receive a voltage from a vehicle associated with the ECU;
a low power transient voltage suppressor (TVS) diode connected via first node to an input node and via a second node to the ECU, the first node being propagated voltage vie the input node, and
a transistor connected, wherein a source of the transistor is connected to the first node and a drain of the transistor is connected to the second node.

2. The circuit according to claim 1, further comprising an input tank capacitor connected to the input node.

3. The circuit according to claim 2, wherein a voltage stored and supplied to the circuit via the input tank transistor is between a cut off threshold voltage of the transistor and a predefined breakdown voltage of the low power TVS diode.

4. The circuit according to claim 1, wherein the transistor is a FET with a predefined breakdown voltage.

5. The circuit according to claim 1, wherein the transistor is a BJT with a predefined breakdown voltage.

6. The circuit according to claim 1, wherein the ECU augments a loading associated with a response to a high energy pulse.

7. The circuit according to claim 1, wherein in response to receiving the high energy pulse via the input node, the low power TVS diode reduces a voltage propagated to the second node by a breakdown voltage.
